(19) United States
(12) Patent Application Publication
(10) Pub. No.: US 2011/0072652 A1
(43) Pub. Date: Mar. 31, 2011

(54) METHOD OF WINDING A PLURALITY OF STATOR TEETH OF A SEGMENTED STATOR CORE

(75) Inventors: Bradley D. Chamberlin, Pendleton, IN (US); Mark A. Stephenson, Fairland, IN (US); Larry A. Kubes, Climax, MI (US)

(73) Assignee: REMY TECHNOLOGIES, L.L.C., Pendleton, IN (US)

(21) Appl. No.: 12/960,628

(22) Filed: Dec. 6, 2010

Related U.S. Application Data
(62) Division of application No. 12/478,901, filed on Jun. 5, 2009.

(51) Int. Cl. H02K 15/00

(52) U.S. Cl. 29/732

(57) ABSTRACT

A winding apparatus includes a mounting fixture configured to support a plurality of stator teeth. The mounting fixture is configured to rotate about an axis defined by each of the plurality of stator teeth. A plurality of stator tooth holding elements are connected to the mounting fixture. The plurality of stator tooth holding elements retain a select one of the plurality of stator teeth relative to the mounting fixture. The mounting fixture is selectively rotated about the central axis of at least one of the plurality of teeth to apply wraps of wire to the one of the plurality of stator teeth while at the same time rotating others of the plurality of stator teeth. A wire guiding member is supported by the mounting fixture. The wire guiding member is configured and disposed to establish a desired length of wire between adjacent ones of the plurality of stator teeth.

### CROSS REFERENCE TO RELATED APPLICATIONS

This application is a divisional application of U.S. Ser. No. 12/478,901, filed Jun. 5, 2009, the contents of which are incorporated by reference herein in their entirety.

### BACKGROUND OF THE INVENTION

The subject matter disclosed herein relates to the art of electric machines having segmented stator cores and, more particularly, to a segmented stator core winding apparatus and a method of winding a segmented stator core of an electric machine.

At present, stator cores are wound with round wire. The stator core is held stationary and the round wire is fed through a winding needle that is rotated about a stator tooth. Once the stator tooth is wound, the wire is advanced to a subsequent stator tooth. At each tooth, the winding needle not only travels along a circular path but also moves in and out to layer the wire. Upon exiting the winding needle, the wire twists as a result of the rotation created when wrapping the stator tooth.

In order to avoid twisting, a segmented stator core is employed. A segmented stator core includes a plurality of individual stator teeth that are joined together to form a stator core. Each tooth is individually wound, and placed in a particular order in a fixture. At this point each tooth is connected to a common bus bar. In the case of a 24 pole stator, as many as 96 connections are required.

### BRIEF DESCRIPTION OF THE INVENTION

According to one aspect of the exemplary embodiment, a winding apparatus for a segmented core having a plurality of stator teeth includes a mounting fixture configured to support select ones of the plurality of stator teeth. The mounting fixture is configured to rotate about an axis defined by each of the plurality of stator teeth. A plurality of stator tooth holding elements are operatively connected to the mounting fixture. Each of the plurality of stator tooth holding elements are configured to retain a select one of the plurality of stator teeth relative to the mounting fixture. The mounting fixture is selectively rotated about the central axis of at least one of the plurality of teeth to apply wraps of wire to the one of the plurality of stator teeth while at the same time rotating others of the plurality of stator teeth. At least one wire guiding member is supported by the mounting fixture. The at least one wire guiding member is configured and disposed to establish a desired length of wire between adjacent ones of the plurality of stator teeth.

### BRIEF DESCRIPTION OF THE DRAWING

The above, as well as other advantages of the present invention, will become readily apparent to those skilled in the art from the following detailed description when considered in light of the accompanying drawings in which:

FIG. 1 is plan view of a winding apparatus for applying rectangular wire to one of a plurality of stator tooth segments without twisting;

FIG. 2 is a plan view of the winding apparatus of FIG. 1 show applying the rectangular wire to another of the plurality of stator teeth segments;

FIG. 3 is a plan view of the winding apparatus of FIG. 1 rotated clockwise ninety (90) degrees shown applying the rectangular wire to yet another of the plurality of stator teeth segments;

FIG. 4 is an elevational view of a plurality of wound stator teeth segments connected to form a segmented stator core;

FIG. 5 is a front elevational view of one of the plurality of stator teeth illustrating the rectangular wire passing through a channel of a cover member.

The detailed description explains embodiments of the invention, together with advantages and features, by way of example with reference to the drawings.

### DETAILED DESCRIPTION OF THE INVENTION

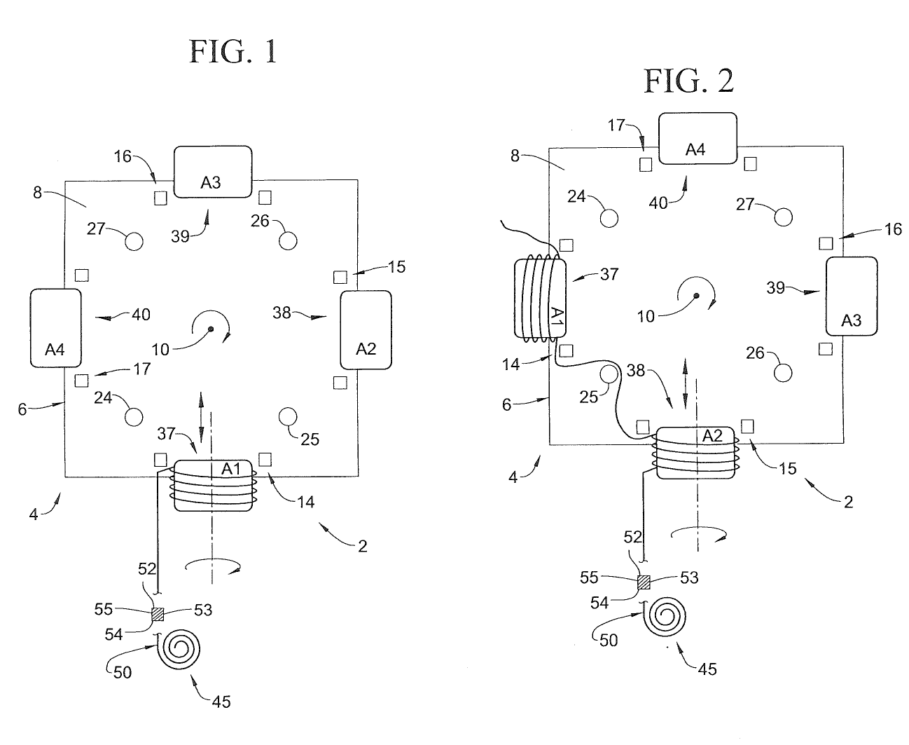

With reference to FIGS. 1-3, a winding apparatus for applying an uninterrupted, continuous and untwisted length of wire to a plurality of stator teeth in accordance with an exemplary embodiment is indicated generally at 2. Winding apparatus 2 includes a mounting fixture 4 having a main body 6. As shown, main body 6 includes a substantially planar surface 8 having a central axis 10. In addition, winding apparatus 2 includes a plurality of stator tooth holding elements 14-17. While only four stator tooth holding elements are shown, it should be understood that the number of stator tooth winding elements provided on winding apparatus 2 can vary. Winding apparatus 2 is also shown to include a plurality of post members 24-27 arranged between adjacent ones of stator tooth holding elements 14-17.

In further accordance with an exemplary embodiment, winding apparatus 2 is configured to receive a plurality of stator teeth 37-40 that are retained by stator tooth holding elements 14-17, respectively. Stator teeth 37-40 represent one pole identified as A₁-A₄ of a segmented stator core. Winding apparatus 2 selectively positions each of the plurality of stator teeth proximate to a winding member 45 loaded with an amount of wire 50. In one exemplary embodiment shown, wire 52 includes a plurality of surfaces that collectively define a rectangular cross-section. Wire 50 is initially attached to stator tooth 37. At this point, mounting fixture 4 rotates about a central axis (not separately labeled) of stator tooth 37. In this manner, wire 50 is applied to stator tooth 37 with few if any twists. That is, stator tooth 37 is wrapped with a number of wraps of wire, with the wire having fewer twists than the total number of wraps. In accordance with one aspect of the invention, the number of twists will be one fewer than the total number of wraps. In accordance with another aspect of the invention, the number of twists will be between one fewer and half the total number of wraps. In accordance with yet another aspect, the number of twists will be fewer than half of the total number of wraps. In accordance with still another aspect of the invention, the wire will remain untwisted.

In addition to rotation, stator tooth 37 oscillates along a liner path defined by the central axis in order to provide proper layering of wire 50. The oscillation is achieved by moving at least one of main body 6, stator tooth holding element 14, and winding member 45. Once applied to stator tooth 37, wire 50 is passed over post 24, main body 6 rotates approximately ninety (90) degrees to position stator tooth 38. (FIG. 2) proximate to winding member 45. Wire 50 is passed from stator tooth 37 around post 24 to stator tooth 38 through a manipulation of mounting fixture 4 and/or winding member 45.

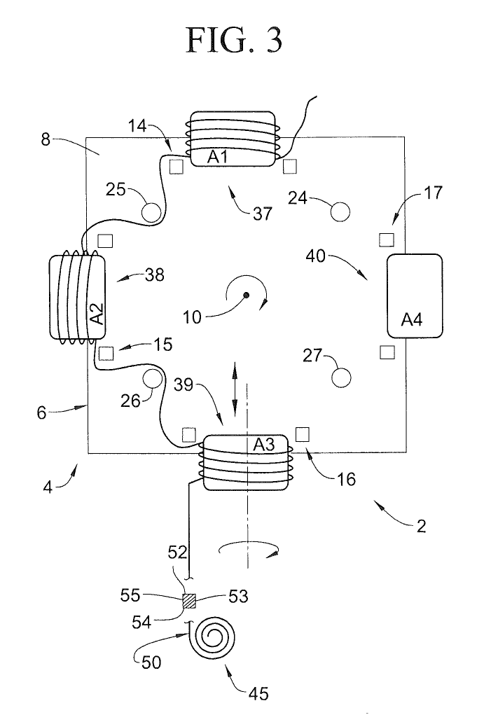

Once wire 50 is positioned at stator tooth 38, mounting fixture 4 begins to rotate about a central axis (not separately labeled) of stator tooth 38. With this arrangement, both stator tooth 37 and stator tooth 38 rotate simultaneously. In a manner similar to that described above, wire 50 is applied to stator tooth 38 with minimal if any twisting. In addition to rotation, stator tooth 38 oscillates along a liner path defined by the central axis in order to provide proper layering of wire 50. The oscillation is achieved by moving at least one of main body 6, stator tooth holding element 15, and winding member 45. Once applied to stator tooth 38, mounting fixture 4 is rotated clockwise approximately ninety (90) degrees to position stator tooth 39 proximate to winding member 45. (FIG. 3)

In addition to rotation, mounting fixture 4 and/or winding member 45 is manipulated to pass wire 50 around post 25. At this point, mounting fixture 4 rotates all of the wrapped stator teeth, e.g., stator teeth 37 and 38 about a central axis (not separately labeled) of stator tooth 39. In this manner, wire 50 is applied to stator tooth 39 with minimal, if any, twisting. In addition to rotation, stator tooth 39 oscillates along a liner path defined by the central axis in order to provide proper layering of wire 50. The oscillation is achieved by moving at least one of the main body 6, stator tooth holding element 14 and winding member 45. Once applied, mounting fixture 4 rotates to position stator tooth 40 proximate to winding member 45. The winding and positioning continues until all teeth for a particular phase or i.e., poles A₁-A₄ as well as poles, i.e., teeth B₁-B₄ for pole B, and teeth C₁-C₄ for any additional phases B and C are wound with a continuous, uninterrupted lengths of untwisted wire.

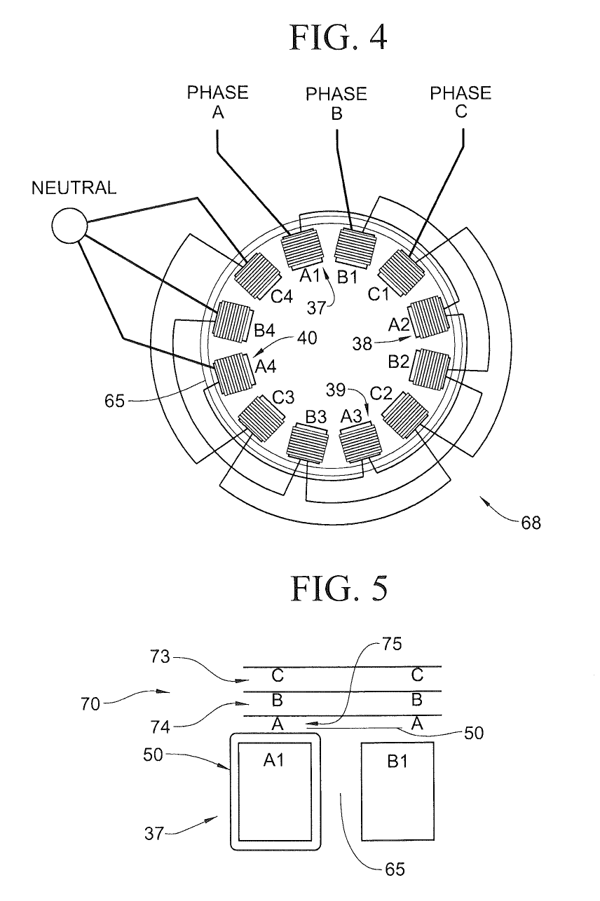

At this point, the plurality of stator teeth 37-40 or poles for phase A as well as the stator teeth or poles for phases B and C are arranged in a particular order and joined to a ring member 65 to form a segmented stator core 68 such as shown in FIG. 4. A cover member 70 (FIG. 5) is positioned on ring member 65 to form a final segmented core member As each phase is wound with a continuous, uninterrupted length of untwisted wire, only two connections are required for each phase, namely a phase connection and a neutral connection. The leads for each pole pass between teeth along respective channels 73-75 that provide any necessary electrical isolation between poles.

In accordance with another aspect, prior to winding the plurality of stator teeth 37-40, cover member 70 is installed around the respective stator teeth 37-40 to provide electrical isolation between the wire 50 and the stator teeth. In addition to providing electrical isolation between the wire 50 and each stator tooth 37-40, cover member 70 is configured to provide electrical isolation between various phases. The electrical isolation is provided by channels 73-75 projecting away from a surface of the stator tooth. During the winding process, wire 50 is placed into an appropriate one of channels 73-75. That is, phase winding A placed in channel 75, phase winding B placed in channel 74, and phase winding C placed in channel 73. Upon completion of winding all desired phase segments, A₁-A₄, B₁-B₄, and C₁-C₄ the phase segments are nested together in a desired pattern.

With this arrangement, the stator teeth for each phase are wound with continuous lengths of untwisted wire. By using a continuous length of wire for each phase, the number of final connections is greatly reduced. That is, segmented stators that utilize individually wrapped stator teeth can require more than 96 connections before assembly is final. Also, by eliminating twists, the use of wire having a rectangular cross section is possible. Wire having a round cross section that twists during application creates a great deal of bulk for each stator tooth. Wire having a rectangular cross section minimizes an overall form factor for each stator tooth allowing for the construction of small electrical machine.

While exemplary embodiments of the invention have been described above, it will be understood that those skilled in the art, both now and in the future, may make various improvements and enhancements which fall within the scope of the claims which follow. These claims should be construed to maintain the proper protection for the invention first described.

1. A winding apparatus for a segmented core having a plurality of stator teeth, the winding apparatus comprising:
a mounting fixture configured to support select ones of the plurality of stator teeth, the mounting fixture being configured to rotate about an axis defined by each of the plurality of stator teeth;
a plurality of stator tooth holding elements operatively connected to the mounting fixture, each of the plurality of stator tooth holding elements being configured to retain a select one of the plurality of a stator teeth relative to the mounting fixture, wherein the mounting fixture is selectively rotated about the central axis of at least one of the plurality of teeth to apply wraps of wire to the one of the plurality of stator teeth while at the same time rotating others of the plurality of stator teeth; and
at least one wire guiding member supported by the mounting fixture, the at least one wire guiding member being configured and disposed to establish a desired length of wire between adjacent ones of the plurality of stator teeth.

2. The winding apparatus according to claim 1, wherein the at least one wire guiding member comprises a post member that extends from the mounting fixture, the post member being arranged between adjacent ones of the plurality of stator tooth holding elements.

3. The winding apparatus according to claim 1, wherein the at least one wire guiding member comprises a plurality of wire guiding members arranged between adjacent ones of each of the plurality of stator tooth mounting elements.

4. The wire winding apparatus according to claim 1, further comprising: a plurality of stator teeth arranged in corresponding ones of the plurality of stator tooth holding elements, each of the plurality of stator teeth having a number of wraps of wire, the wraps of wire including a number of twists that is fewer than a total number of wraps.

5. The wire winding apparatus according to claim 4, wherein the number of twists of wire is one less than the total number of wraps of wire.

6. The wire winding apparatus according to claim 4, wherein the number of twists will be between one less than and half the total number of wraps of wire.

7. The wire winding apparatus according to claim 4, wherein each of the plurality of stator teeth is wound with a continuous, uninterrupted length of untwisted wire to establish an electric phase.

8. The winding apparatus according to claim 1, further comprising: a winding member positioned to direct a rectangular wire onto each of the plurality of stator teeth.

9. The wire winding apparatus according to claim 1, wherein the mounting fixture is configured and disposed to rotate about a central axis defined by the plurality of stator tooth holding elements.

10. The wire winding apparatus according to claim 1, wherein the mounting fixture is configured and disposed to oscillate along a linear axis defined by each of the plurality of stator tooth mounting elements.

11. The wire winding apparatus according to claim 1, wherein each of the plurality of stator tooth mounting elements is configured and disposed to oscillate along a linear axis.
